(19) United States
(12) Patent Application Publication
(10) Pub. No.: US 2022/0186746 A1
(43) Pub. Date: Jun. 16, 2022

(54) CENTRIFUGAL OR MIXED-FLOW COMPRESSOR INCLUDING ASPIRATED DIFFUSER

(71) Applicant: Carrier Corporation, Palm Beach Gardens, FL (US)

(72) Inventors: Michael M. Joly, Palm Beach Gardens, FL (US); Chaitanya Vishwajit Halbe, Palm Beach Gardens, FL (US); Vishnu M. Sishtla, Palm Beach Gardens, FL (US)

(21) Appl. No.: 17/255,913

(22) PCT Filed: Jul. 20, 2020
(86) PCT No.: PCT/US2020/042702

§ 371 Date: Dec. 23, 2020

Related U.S. Application Data
(60) Provisional application No. 62/876,913, filed on Jul. 22, 2019.

(51) Int. Cl. F04D 29/44; F04D 17/06; F04D 29/68

(52) U.S. Cl. CPC F04D 29/444; F04D 29/682; F04D 17/06

(57) ABSTRACT

A compressor including a casing and an impeller arranged within the casing. The impeller is rotatable about an axis. A diffuser section is arranged within the casing. The diffuser section is positioned downstream from an outlet of the impeller and includes a first set of vanes disposed circumferentially about the diffuser section and a second set of vanes disposed circumferentially about the diffuser section. At least one vane in the second set of vanes includes an aspiration slot.

### CROSS-REFERENCE TO RELATED APPLICATION

This application claims priority to U.S. Provisional Application No. 62/876,913 filed on Jul. 22, 2019.

### TECHNICAL FIELD

The present disclosure relates generally to centrifugal or mixed-flow compressors, and more specifically to a diffuser configuration for a centrifugal or a mixed-flow compressor.

### BACKGROUND

Rotary machines, such as compressors, are commonly used in refrigeration and turbine applications. One example of a rotary machine used in refrigeration systems includes a centrifugal compressor having an impeller fixed to a rotating shaft. Rotation of the impeller increases a pressure and/or velocity of a fluid or gas moving across the impeller.

In applications using a low pressure refrigerant, the impeller can have a supersonic outlet flow. One way of reducing the Mach number at the impeller outlet is to use a tandem vane set protruding from a fixed diffuser. The high-Mach number flow is decelerated with the first vane set and conventional subsonic diffuser flow is achieved via turning with the second vane set. In this configuration it can be difficult to mitigate the total pressure loss across the vane set used to condition the flow to a conventional flow, and this in turn can lead to strong corner separation at the vane roots of the second vane set.

### SUMMARY OF THE INVENTION

In one exemplary embodiment a compressor includes a casing, an impeller arranged within the casing, the impeller being rotatable about an axis, and a diffuser section arranged within the casing, the diffuser section being positioned downstream from an outlet of the impeller, and including a first set of vanes disposed circumferentially about the diffuser section and a second set of vanes disposed circumferentially about the diffuser section, at least one vane in the second set of vanes including an aspiration slot.

In another example of the above described compressor each vane in the second set of vanes includes the aspiration slot.

In another example of any of the above described compressors each vane in the second set of vanes is identical.

In another example of any of the above described compressors the aspiration slot is a radially aligned intrusion into a suction side of the at least one vane.

In another example of any of the above described compressors the radially aligned intrusion extends from a root of the suction side of the at least one vane.

In another example of any of the above described compressors the radially aligned intrusion extends a partial radial span of the at least one vane.

Another example of any of the above described compressors further includes a second radially aligned intrusion, wherein the second radially aligned intrusion is positioned at a same axial position on the at least one vane as the first radially aligned intrusion.

In another example of any of the above described compressors the aspiration slot is connected to an outlet via a hole and wherein the outlet is disposed at one of a tip of the at least one vane, and a hub of the at least one vane.

Another example of any of the above described compressors further includes a plurality of aspiration slots disposed on the at least one vane, and wherein each of the aspiration slots is connected to the outlet via a corresponding hole.

In another example of any of the above described compressors fluid communication between each of the aspiration slots and the corresponding outlet is controlled via a controllable valve.

In another example of any of the above described compressors the at least one vane includes a plurality of aspiration slots, and each aspiration slot is connected to a distinct outlet via a corresponding hole, each of the outlets being disposed at one of a tip of the at least one vane, and a hub of the at least one vane.

In another example of any of the above described compressors the compressor is one of a mixed-flow compressor and a centrifugal compressor.

An exemplary method for reducing boundary layer separation in a compressor, the method includes aspirating a flow from a suction side of a vane in a diffuser section to one of a tip of the vane and a radially inward hub of the vane through an aspiration slot, wherein the aspiration slot is disposed at a primary flow separation location.

In another example of the above described method for reducing boundary layer separation in a compressor aspirating the flow comprises allowing fluid to flow through the aspiration slot to an outlet disposed at one of the tip of the vane and the radially inward hub of the vane.

In another example of any of the above described methods for reducing boundary layer separation in a compressor aspirating the flow comprises aspirating the flow through a plurality of aspiration slots disposed on the suction side of the vane.

In another example of any of the above described methods for reducing boundary layer separation in a compressor the flow from each of the aspiration slots is provided to a shared outlet.

In another example of any of the above described methods for reducing boundary layer separation in a compressor the flow from each of the aspiration slots is provided to distinct outlets.

In one exemplary embodiment a vane for a compressor, wherein the vane includes a leading edge connected to a trailing edge via a pressure side surface and a suction side surface, and an aspiration slot disposed in the suction side surface, wherein the aspiration slot is a radially aligned intrusion into the suction side surface.

In another example of the above described vane for a compressor the aspiration slot is connected to an outlet via a hole and wherein the outlet is disposed at one of a tip of the vane and a radially inward hub of the vane.

Another example of any of the above described vanes for a compressor further includes at least a second aspiration slot disposed on the suction side surface.

These and other features of the present invention can be best understood from the following specification and drawings, the following of which is a brief description.

### BRIEF DESCRIPTION OF THE DRAWINGS

FIG. 1 schematically illustrates a cross section of an exemplary mixed-flow compressor.

FIG. 2 schematically illustrates an exemplary isometric view of a diffuser section of the mixed-flow compressor of FIG. 1.

FIG. 3 schematically illustrates an isometric view of a single vane in a second set of vanes of the diffuser section of FIG. 2.

FIG. 4 schematically illustrates an isometric view of another example single vane in a second set of vanes for the diffuser section of FIG. 2.

FIG. 5 schematically illustrates an isometric view of another example single vane in a second set of vanes for the diffuser section of FIG. 2.

FIG. 6 schematically illustrates an isometric view of another example single vane in a second set of vanes for the diffuser section of FIG. 2.

FIG. 7 illustrates a cross sectional view of an exemplary vane in the second set of vanes of FIG. 2.

FIG. 8 illustrates a cross sectional view of another exemplary vane in the second set of vanes of FIG. 2.

### DETAILED DESCRIPTION

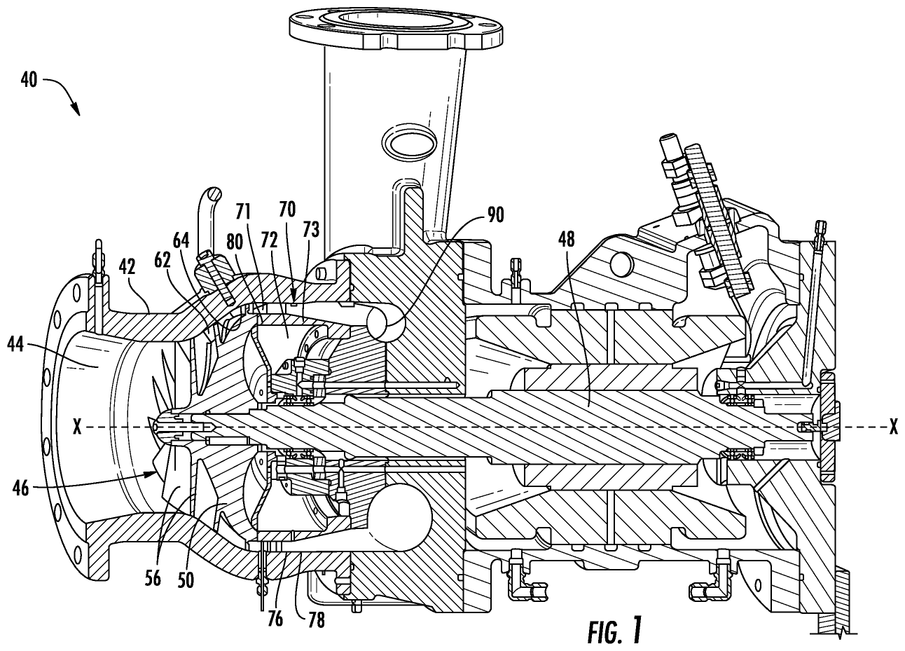

FIG. 1 schematically illustrates an example mixed-flow compressor 40. The compressor 40 includes a main casing or housing 42 having an inlet 44 through which a fluid, such as a refrigerant, is directed axially toward a rotating impeller 46. The impeller 46 is secured to a drive shaft 48 such that the impeller 46 is aligned with the axis X of the compressor 40 and rotates along with the shaft 48.

The impeller 46 includes a hub or body 50 having a front side and a back side. The diameter of the front side of the body 50 generally increases toward the back side such that the impeller 46 is conical in shape. A plurality of blades or vanes 56 extends outwardly from the body 50. Each of the plurality of blades 56 is arranged at an angle to the axis of rotation X of the shaft 48 and the impeller 46. In one example, each of the blades 56 extends between the front side and the back side of the impeller 46. Each blade 56 includes a first end arranged generally adjacent a first end of the hub 50 and a second end located generally adjacent the back side of the impeller 46. Further, the second end of the blade 56 is circumferentially offset from the corresponding first end of the blade 56.

Multiple passages 62 are defined between adjacent blades 56 to discharge a fluid passing over the impeller 46 generally parallel to the axis X. As the impeller 46 rotates, fluid approaches the front side of the impeller 46 in a substantially axial direction and flows through the passages 62 defined between adjacent blades 56. Because the passages 62 have both an axial and radial component, the axial flow provided to the front surface of the impeller 46 simultaneously moves both parallel to and circumferentially about the axis of the shaft 48. In combination, the inner surface of the housing 42 and the passages 62 of the impeller 46 cooperate to discharge the compressed refrigerant fluid from the impeller 46. The compressed fluid is discharged from the impeller 46 at any angle relative to the axis X of the shaft 48 into an adjacent diffuser section 70.

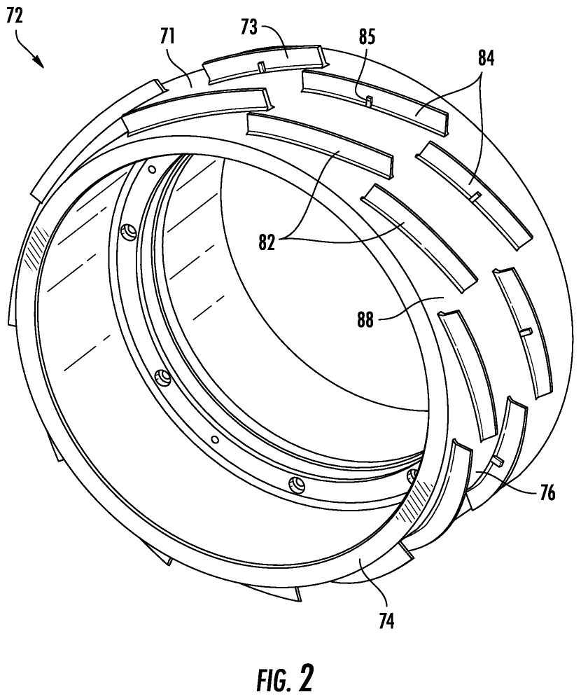

With continued reference to FIG. 1, FIG. 2 schematically illustrates an isometric view of an exemplary diffuser section 70. The diffuser section 70 includes a diffuser structure 72 mounted generally circumferentially about the shaft 48, at a location downstream from the impeller 46 relative to the direction of flow through the compressor 40. When the diffuser structure 72 is mounted within the compressor 40, a first end 74 of the diffuser structure 72 may directly abut the back side of the impeller 46. In alternative examples, a clearance may be included between the back side of the impeller 46 and the diffuser 70. Further, the diffuser structure 72 may be mounted such that an outer surface 76 thereof is substantially flush with the front surface 52 of the impeller 46 at the interface with the back surface.

The diffuser structure 72 includes a forward portion 71 including a first set of vanes 82 protruding radially outward from the forward portion 71. The forward portion 71 is stationary relative to the shaft 48, i.e. it does not rotate along with the shaft 48. A second set of vanes 84, downstream of the first set of vanes 82, protrudes radially outward from the diffuser section 72. In some examples, the diffuser section includes only the forward portion 71 and both sets of vanes protrude from the forward section 71. In alternative examples, such as the illustrated example, the diffuser section 71 includes an aft portion 73, with the second set of vanes protruding from the aft portion 73. The aft portion 73 can be fixed relative to the forward portion 71, or allowed to freely rotate relative to the forward section 71 depending on the operating parameters of the compressor including the diffuser structure 72.

The first set of circumferentially spaced vanes 82 is affixed about the outer surface 76, and extends radially outward from, the outer surface 76 in the forward portion 71. The plurality of vanes 82 are substantially identical to each other in one example. Alternatively, the vanes 82 vary in size and/or shape in another example. The plurality of vanes 82 are oriented at an angle to the axis of rotation X of the shaft 48.

The second set of vanes 84 are also circumferentially spaced about the outer surface 76 and extend radially outward from the outer surface. In order to reduce corner separation of flow through the second set of vanes, each of the vanes 84 includes a slot 85 on the suction side of the vane at the position on the vane where the flow is prone to separation. Each slot 85 is connected to an internal passage within the vane 84 (illustrated in FIGS. 3-9) which is connected to a lower pressure region within the chiller. The combination of the slot 85 and the internal passage provides a passageway that creates a natural aspiration of the boundary layer on the vane 85 suction side. This in turn reduces the boundary layer separation and improves performance.

As the refrigerant passes through passageways 88 defined between adjacent vanes 82 of the diffuser structure 72, the kinetic energy of the refrigerant is converted to a potential energy or static pressure, which reduces the speed of the fluid to subsonic conditions. In one embodiment, the configuration of the vanes 82 is selected to reduce a Mach number of the fluid flow, such as by up to 50% or more. In another embodiment, inclusion of the vanes 82 reduces the Mach number of the flow from above 1 to between about 0.2 and 0.8. Further, it, should be understood that the diffuser structure 72 illustrated and described herein is intended as an example only and that other diffuser structures having an axial flow configuration and arranged in fluid communication with the passages 62 of the impeller 46 are also contemplated herein. The freely rotating portion 73 of the diffuser section 70 receives the now subsonic flow and further conditions the flow to be a conventional flow.

In this configuration, the fluid flow through the compressor 40 smoothly transitions from the impeller 46 to the diffuser section 70. Although the mixed-flow impeller illustrated and described herein is unshrouded, embodiments including a shroud is disposed circumferentially about the impeller 46 are also within the scope of the disclosure.

With continued reference to FIGS. 1 and 2, FIG. 3 schematically illustrates a single exemplary vane 200 of the second set of vanes 84 of FIG. 2. The vane defines an airfoil profile, and has a suction side 210 and a pressure side 220. An aspiration slot 230 is defined on the suction side 210. The aspiration slot is an intrusion into the vane 200, with the intrusion extending radially, relative to a radius of the diffuser portion 72 including the vane 200. The aspiration slot 230 is included at a location on the vane 200 most susceptible to boundary layer separation. The illustrated example aspiration slot 230 extends from the root of the vane 200 partially radially outward along the suction side surface 210. In one specific examples, the aspiration slot 230 is positioned midway between a leading edge 212 and a trailing edge 214 of the vane 200 and extends from 0% span (the root 232) to approximately 50% span of the vane 200.

In the illustrated example, the aspiration slot 230 is connected to a tip 202 of the vane 200 via a cylindrical hole 240. In alternative examples, the aspiration slot 230 can be connected to a hub portion radially inward of the vane 200 through a root portion of the vane 200.

During operation of the compressor, the higher pressure at the aspiration slot 230 causes the boundary layer to be aspirated on the suction side 210 and mitigates, or eliminates, the boundary layer separation at the location of the aspiration slot 230.

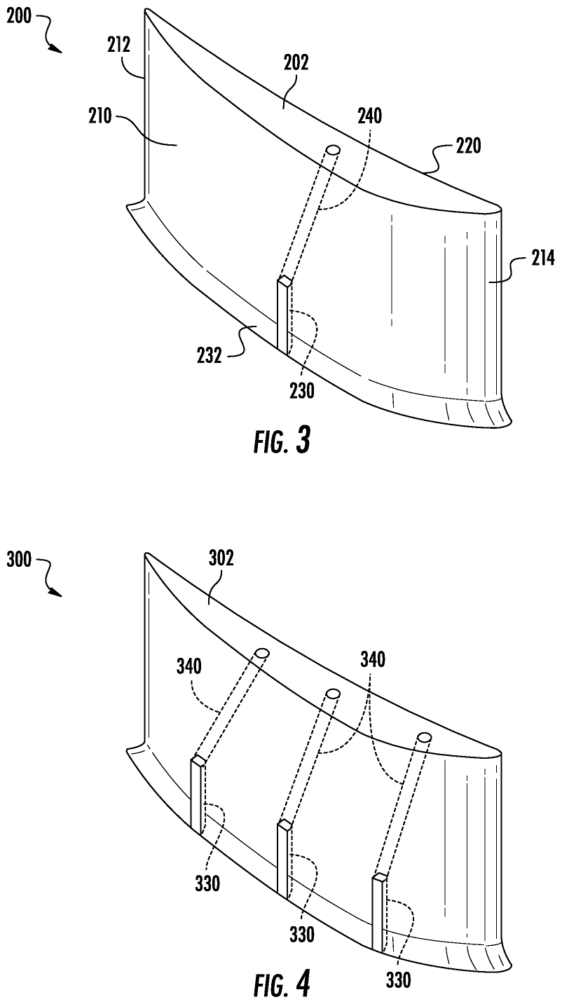

With continued reference to FIG. 3, FIG. 4 schematically illustrates an exemplary vane 300 including multiple aspiration slots 330, each of which is connected to the tip 302 via a corresponding cylindrical hole 340. The specific location and number of each aspiration slot 330 is determined to correspond to the locations of the vane 300 that are susceptible to boundary layer separation.

With continued reference to FIGS. 1-4, FIG. 5 schematically illustrates another example vane 400, including multiple aspiration slots 430, each positioned at a suction side location susceptible to boundary layer separation. Unlike the vane 300 of FIG. 4, the vane 400 of FIG. 5 includes multiple cylindrical holes 440, 442, each of which is connected to an outlet 444 via a controllable valve 446. The controllable valve 446 can open and/or close connections between the aspiration slots 430 and the outlet 444, such that any given aspiration slot is only connected during a compressor operating condition where the location of the aspiration slot 430 is susceptible to boundary layer separation.

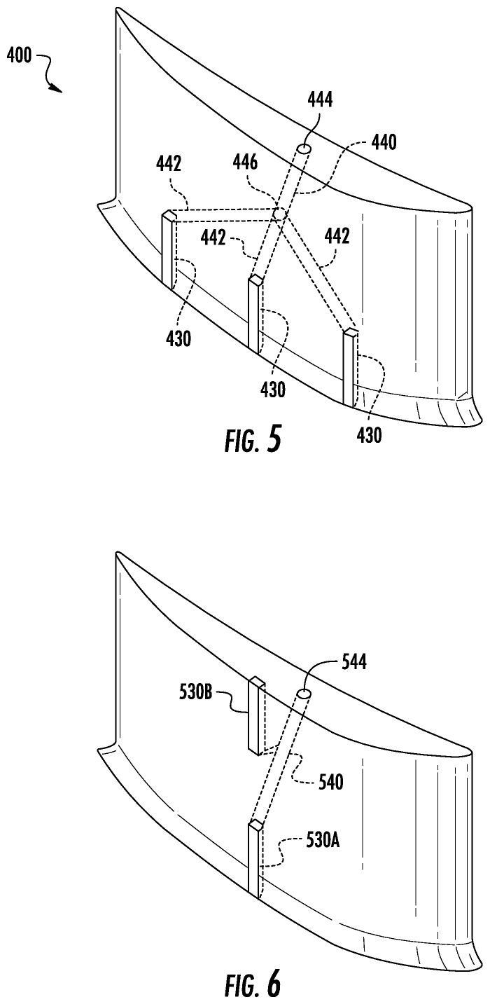

With continued reference to each of the previous examples, FIG. 6 illustrates yet a further example vane 500 including an aspiration slot 530 including a radially inward portion 530A and a radially outward portion 530B. Each of the portions are connected via a single cylindrical hole to an outlet 644. In the example of FIG. 6, each slot 530 includes multiple segments 530A, 530B at any given location along the pressure surface 520. In alternative examples, the aspiration slot 530 can extend the full height of the vane 500, without the break at the mid span, depending on the specific need of the compressor system.

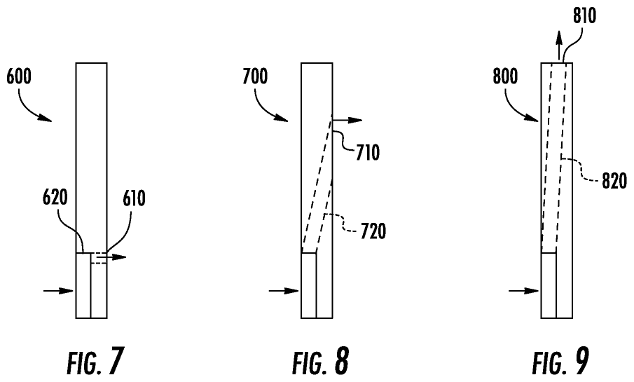

With continued reference to FIGS. 1-6, FIGS. 7 and 8 each illustrate a side view of exemplary vanes 600, 700. Each Figure illustrates alternative outlet 610, 710 locations for the corresponding cylindrical hole 620, 720, with the outlet 610 in FIG. 7 being positioned at the tip, and the outlet 710 of FIG. 8 being positioned at the hub 730.

With reference now to the vanes 200-700 of FIGS. 3-8, it is appreciated that each of the varied aspiration slot configurations can be utilized on its own or in any combination with any number of other aspiration slot configurations on any given vane 200-700. In some example systems, such as that of FIG. 2, each vane 84 in the second portion 73 of the diffuser structure 72 is identical to each other vane 84. In alternative examples each vane 84 can have a unique aspiration slot configuration corresponding to that specific vane 84, and the unique aspiration slot configurations can be determined empirically for a given compressor or based on theoretical modeling of a model compressor.

While described and illustrated herein within the context of a mixed-flow compressor system, one of skill in the art will appreciate that a radial flow compressor system could incorporate the features described herein and the concept is not limited in scope to mixed-flow compressors. Further, while the configurations of FIGS. 1-9 are illustrated independently, it is appreciated that any given compressor system can incorporate multiple illustrated configurations in combination and the examples are not mutually exclusive within a single compressor.

It is further understood that any of the above described concepts can be used alone or in combination with any or all of the other above described concepts. Although an embodiment of this invention has been disclosed, a worker of ordinary skill in this art would recognize that certain modifications would come within the scope of this invention. For that reason, the following claims should be studied to determine the true scope and content of this invention.

1. A compressor comprising:
a casing;
an impeller arranged within the casing, the impeller being rotatable about an axis; and
a diffuser section arranged within the casing, the diffuser section being positioned downstream from an outlet of the impeller, and including a first set of vanes disposed circumferentially about the diffuser section and a second set of vanes disposed circumferentially about the diffuser section, at least one vane in the second set of vanes including an aspiration slot.

2. The compressor of claim 1, wherein each vane in the second set of vanes includes the aspiration slot.

3. The compressor of claim 1, wherein each vane in the second set of vanes is identical.

4. The compressor of claim 1, wherein the aspiration slot is a radially aligned intrusion into a suction side of the at least one vane.

5. The compressor of claim 4, wherein the radially aligned intrusion extends from a root of the suction side of the at least one vane.

6. The compressor of claim 5, wherein the radially aligned intrusion extends a partial radial span of the at least one vane.

7. The compressor of claim 6, further comprising a second radially aligned intrusion, wherein the second radially aligned intrusion is positioned at a same axial position on the at least one vane as the first radially aligned intrusion.

8. The compressor of claim 4, wherein the aspiration slot is connected to an outlet via a hole and wherein the outlet is disposed at one of a tip of the at least one vane, and a hub of the at least one vane.

9. The compressor of claim 8, further comprising a plurality of aspiration slots disposed on the at least one vane, and wherein each of the aspiration slots is connected to the outlet via a corresponding hole.

10. The compressor of claim 9, wherein fluid communication between each of the aspiration slots and the corresponding outlet is controlled via a controllable valve.

11. The compressor of claim 4, wherein the at least one vane includes a plurality of aspiration slots, and each aspiration slot is connected to a distinct outlet via a corresponding hole, each of the outlets being disposed at one of a tip of the at least one vane, and a hub of the at least one vane.

12. The compressor of claim 1, wherein the compressor is one of a mixed-flow compressor and a centrifugal compressor.

13. A method for reducing boundary layer separation in a compressor, the method comprising:
aspirating a flow from a suction side of a vane in a diffuser section to one of a tip of the vane and a radially inward hub of the vane through an aspiration slot, wherein the aspiration slot is disposed at a primary flow separation location.

14. The method of claim 13, wherein aspirating the flow comprises allowing fluid to flow through the aspiration slot to an outlet disposed at one of the tip of the vane and the radially inward hub of the vane.

15. The method of claim 13, wherein aspirating the flow comprises aspirating the flow through a plurality of aspiration slots disposed on the suction side of the vane.

16. The method of claim 15, wherein the flow from each of the aspiration slots is provided to a shared outlet.

17. The method of claim 16, wherein the flow from each of the aspiration slots is provided to distinct outlets.

18. A vane for a compressor, wherein the vane comprises:
a leading edge connected to a trailing edge via a pressure side surface and a suction side surface; and
an aspiration slot disposed in the suction side surface, wherein the aspiration slot is a radially aligned intrusion into the suction side surface.

19. The vane of claim 18, wherein the aspiration slot is connected to an outlet via a hole and wherein the outlet is disposed at one of a tip of the vane and a radially inward hub of the vane.

20. The vane of claim 18, further comprising at least a second aspiration slot disposed on the suction side surface.
